(19) United States
(12) Patent Application Publication
(10) Pub. No.: US 2007/0206038 A1
(43) Pub. Date: Sep. 6, 2007

(54) Ink jet printing with multiple conveyors

(76) Inventor: Richard Baker, West Lebanon, NH (US)

Correspondence Address: FISH & RICHARDSON P.C., PO BOX 1022, MINNEAPOLIS, MN, 55440-1022, US

(21) Appl. No.: 11/367,122

(22) Filed: Mar. 3, 2006

(51) Int. Cl. B41J 25/308

(52) U.S. Cl. 347/8

(57) ABSTRACT

A fluid delivery system includes a first conveyor adapted to transport a substrate and a second conveyor disposed adjacent to the first conveyor. The second conveyor is configured to receive the substrate across a gap from the first conveyor. A fluid delivery head is disposed above the gap between the first conveyor and the second conveyor.

### TECHNICAL FIELD

This application relates to the field of ink jet printing.

### BACKGROUND

Ink jet printing is a non-impact method that produces droplets of ink that are deposited on a substrate such as paper or transparent film in response to an electronic digital signal. In various commercial or consumer applications, there is a general need to provide ink jet images that are printed edge-to-edge on a substrate. There is also a need for printing ink images on irregular and/or small substrates such as candy and cookies.

Ink jet printing systems generally are of two types: continuous stream and drop-on-demand. In continuous stream ink jet systems, ink is emitted in a continuous stream under pressure through at least one orifice or nozzle. Multiple orifices or nozzles also may be used to increase imaging speed and throughput. The ink is ejected out of orifices and perturbed, causing it to break up into droplets at a fixed distance from the orifice. At the break-up point, the electrically charged ink droplets are passed through an applied electric field that is controlled and switched on and off in accordance with digital data signals. Charged ink droplets are passed through a controllable electric field, which adjusts the trajectory of each droplet in order to direct it to either a gutter for ink deletion and recirculation or a specific location on a recording medium to create images. The image creation is controlled by electronic signals.

In drop-on-demand systems, a droplet is ejected from an orifice directly to a position on a recording medium by pressure created by, for example, a piezoelectric device, an acoustic device, or a thermal device controlled in accordance with digital data signals. An ink droplet is not generated and ejected through the nozzles of an imaging device unless it is to be placed on the recording medium.

### SUMMARY

In one aspect, a fluid delivery system includes a first conveyor to transport a substrate, a second conveyor disposed adjacent to the first conveyor, the second conveyor being configured to receive the substrate across a gap from the first conveyor and a fluid delivery disposed above the gap between the first conveyor and the second conveyor.

In an aspect, a fluid delivery system includes a first conveyor to transport a substrate, a second conveyor disposed adjacent to the first conveyor, the second conveyor being configured to receive the substrate across a gap from the first conveyor and a fluid delivery head configured to eject fluid drops on the substrate when the substrate is transported over a gap from the first conveyor to the second conveyor.

In one aspect, a method for printing an ink image on a substrate includes transporting a substrate from a first conveyor across a gap to a second conveyor and ejecting ink drops from an ink jet print head to the substrate when the substrate is transported over the gap between the first conveyor and the second conveyor.

Implementations of the system may include one or more of the following. A fluid delivery system includes a first conveyor adapted to transport a substrate, a second conveyor disposed adjacent to the first conveyor, wherein the second conveyor is configured to receive the substrate across a gap from the first conveyor, and a fluid delivery head disposed above the gap between the first conveyor and the second conveyor. The fluid delivery head can be configured to eject fluid drops on the substrate when the substrate is transported over the gap from the first conveyor to the second conveyor. The fluid delivery head can be configured to print a fluid pattern that is full bleed at least along one edge of the substrate. The fluid delivery system can further include a controller that can control the fluid drop ejection from the fluid delivery head. The fluid delivery system can further include a first motor operatively coupled to the first conveyor and controlled by the controller, said first motor being configured to control the first conveyor. The fluid delivery system can further include a second motor operatively coupled to the second conveyor and controlled by the controller, said second motor being configured to control the second conveyor. The first conveyor can further include one or more of a drive roller, a passive roller, a conveyance belt, and a motor. The second conveyor can further include one or more of a drive roller, a passive roller, a conveyance belt, and a motor. The fluid delivery system can further include one or more sensors configured to detect substrate and its position and to generate a substrate location signal that can be used to control the ejection of the fluid drops. The fluid delivery system can further include one or more sensors configured to detect the orientation of the substrate and to generate a substrate orientation signal that can be used to control the ejection of the fluid drops. The fluid delivery system can further include a fluid collector disposed below the gap between the first conveyor and the second conveyor for collecting overspray fluid drops ejected by the fluid delivery head.

The fluid delivery system can further include a fluid absorbent material over the fluid collector for collecting overspray fluid drops ejected by the fluid delivery head. The fluid absorbing material can be replaceable. The fluid delivery system can further include a fluid reservoir configured to supply fluid to the fluid delivery head. The fluid delivery device is an ink jet print head.

Embodiments may include one or more of the following advantages. The disclosed ink jet system provides ink jet printing in a gap between two sequentially positioned conveyors and the collection of the overspray inks below the gap. The disclosed ink jet system is capable of full bleed printing without contamination of the substrate by the overspray inks. The disclosed ink jet system is capable of printing ink images on substrates without the need of pre-aligning the substrates before printing. Furthermore, the system provides effective methods and mechanisms for cleaning the overspray inks.

The details of one or more embodiments are set forth in the accompanying drawing and in the description below. Other features, objects, and advantages of the invention will become apparent from the description and drawings, and from the claims.

### BRIEF DESCRIPTION OF THE DRAWINGS

FIG. 1 illustrates an ink jet printing system capable of full-bleed printing.

### DETAILED DESCRIPTION

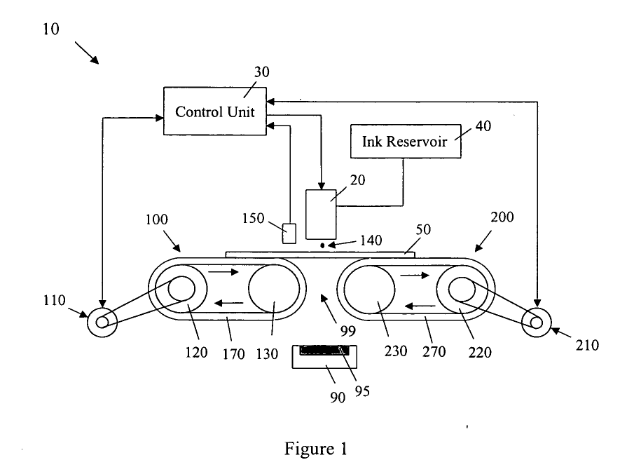

FIG. 1 shows an ink jet printing system 10 including a first conveyor 100 and a second conveyor 200. The second conveyor 200 is positioned downstream to the first conveyor 100 and is separated from the first conveyor 100 by a gap 99. An ink jet print head 20 is disposed over the gap 99 between the first conveyor 100 and the second conveyor 200. The ink jet print head 20 may include one or more ink nozzles through which ink drops 140 can be ejected. The ink jet printing system 10 further includes a controller unit 30 and an ink reservoir 40 for supplying ink to the ink jet print head 20. A substrate 50 can be sequentially transported by the first conveyor 100 and the second conveyor 200. The ink jet printing system 10 can also include one or more sensors 150 for detecting the location and/or the orientation of the substrate 50 to produce substrate position signals. The substrate position signals are sent to the control unit 30 for controlling the ejection of the ink drops from the ink jet print head 20.

The first conveyor 100 includes a conveyor belt 170, a drive roller 120 for driving the conveyor belt 170, a motor 110 that can drive the drive roller 120 under the control of the control unit 30, and a passive roller 130. The substrate 50 is carried and transported by the conveyor belt 170 toward the second conveyor 200 that is down stream to the first conveyor 100. The second conveyor 200 includes a conveyor belt 270, a drive roller 220 for driving the conveyor belt 270, a motor 210 that can drive the drive roller 220 under the control of the control unit 30, and a passive roller 230.

The substrate 50 is moved under the ink jet print head 20 and then received by the second conveyor 200 that can continue to transport the substrate 50 at the same speed. The location of the substrate 50 is detected by the sensor 150 when it moves over the gap 99 between the first conveyor 100 and the second conveyor 200. The sensor 150 produces substrate location signals that can be received by the control unit 30. The control unit 30 provides image data and other digital data to the ink jet print head 20 and controls the ink jet print head 20 to eject ink drops 140 onto the substrate 50.

In an embodiment, the ink jet print head 29 can print edge-to-edge across the substrate 50. The accurate sensing of the lead and the rear edges of the substrate 50 by the sensor 150 allows the placement of ink drops 140 from the lead edge of the substrate 50, thus forming a full bleed ink pattern on the substrate 50. Along a substrate edge to be printed full bleed, the control unit 30 prepares the image data and controls the ink jet print head 20 such that it prints slightly over the edge so that a full ink image is produced without a blank margin along the edge. In the present application, the term “full bleed” is used to describe an image that extends up to one or more edges of a substrate. The term “full bleed” can also describe a printed image without borders along one or more edges of an substrate.

In an embodiment, the ink jet print head 20 is transported by a print head transport system along a fast scan direction while the substrate 50 is transported by the first conveyor 100 and the second conveyor 200 along a slow scan direction. The ink jet print head 20 can dispose ink drops on the substrate 50 from one side edge to another in each printing swath along the fast scan direction. The detection of the lead and rear edges of the substrate 50 allows the full bleed printing of ink image along all four edges of the substrate 50.

In an embodiment, one or more sensors 150 can detect the orientation of the substrate 50 in addition to substrate position. Substrate orientation signals subsequently produced are sent to the control unit 30. In response, the image data are processed such that the ink pattern to be disposed will be automatically adjusted according to the specific orientation of the substrate 50. One advantage of the orientation detection and image printing adjustment is that the substrate 50 does not need to be aligned in any particular orientation on the first conveyor 100. Another advantage is that irregular shaped substrates having one or more non-straight edges can be printed full bleed using the disclosed ink jet printing system 10.

For example, as a rectangular-shaped substrate moves along the first conveyor 100, the substrate may pass under the print head 20 at a 45° angle. One or more sensors 150 can detect that the rectangular-shaped substrate is traveling at a 45° angle. Once the sensors 150 detect the orientation of the rectangular-shaped, a substrate orientation signal is sent to the control unit 30. Then, the image data is processed such that the ink pattern will be adjusted to a 45° angle. In another embodiment, one or more sensors send signals to a control unit. The control unit detects the orientation of the substrate and adjusts the image data to the orientation of the substrate.

The ink drops ejected from the print head 20 beyond the substrate edges can be referred to as overspray ink. As shown in FIG. 1, the overspray ink is collected by an ink collector 90 disposed below the gap 99. An ink absorbing material 95 can be placed over the ink collector 90 to absorb the overspray ink and to prevent ink accumulation. The ink absorbing material 95 can be replaced or disposed from time to time to keep the system clean. The absorbent material 95 can include man made or natural materials. The absorbent material 95 can also be tailored to be most effective in absorbing the specific types of inks used for each batch of substrates: for example, aqueous or solvent types of inks. The ink collector 90 can be fluidly connected with an waste ink reservoir 97 through an ink line 98 to allow excess ink collected in the ink collector 90 to over flow into the waste ink reservoir 97. Effective removal of waste inks allows the ink jet printing system 10 long periods of continuous printing operation without maintenance. Furthermore, different colored ink fluids may each include an ink collector under the corresponding ink jet print head and below the gap 99. The waste ink can be recycled for future printing operations.

Ink types compatible with the ink jet printing system described include water-based inks, solvent-based inks, and hot melt inks. The colorants in the inks can comprise dyes or pigments. Furthermore, the ink jet printing system is also compatible with delivering other fluids such as polymer solutions, gel solutions, solutions containing particles, low molecular-weight molecules, which may or may not include any colorant, flavors, nutrients, biological fluids, or electronic fluids.

An advantage of the disclosed system and methods is that full-bleed ink jet printing in the gap between two sequentially positioned conveyors and the collection of the overspray inks below the gap assures that the overspray inks are not accumulated on the conveyor belts 170 and 270. The underside and the edges of the substrate 50 are therefore not contaminated by the overspray inks.

What is claimed is:

1. A fluid delivery system, comprising:
a first conveyor to transport a substrate;
a second conveyor disposed adjacent to the first conveyor, the second conveyor being configured to receive the substrate across a gap from the first conveyor; and
a fluid delivery head disposed above the gap between the first conveyor and the second conveyor.

2. The fluid delivery system of claim 1, wherein the fluid delivery head is configured to eject fluid drops on the substrate when the substrate is transported over the gap from the first conveyor to the second conveyor.

3. The fluid delivery system of claim 2, wherein the fluid delivery head is configured to print a fluid pattern that extends at least up to one edge of the substrate.

4. The fluid delivery system of claim 1, further comprising a controller that can control the fluid drop ejection from the fluid delivery head.

5. The fluid delivery system of claim 4, further comprising a first motor operatively coupled to the first conveyor and controlled by the controller, said first motor being configured to control the first conveyor.

6. The fluid delivery system of claim 5, further comprising a second motor operatively coupled to the second conveyor and controlled by the controller, said second motor being configured to control the second conveyor.

7. The fluid delivery system of claim 1, wherein the first conveyor further comprises one or more of a drive roller, a passive roller, a conveyance belt or a motor.

8. The fluid delivery system of claim 1, wherein the second conveyor further comprises one or more of a drive roller, a passive roller, a conveyance belt or a motor.

9. The fluid delivery system of claim 1, further comprising one or more sensors configured to detect the substrate and its position and to generate a substrate position signal.

10. The fluid delivery system of claim 1, wherein the fluid delivery head is configured to eject fluid drops on the substrate in response to the substrate position signal.

11. The fluid delivery system of claim 1, further comprising a fluid collector disposed below the gap between the first conveyor and the second conveyor to collect fluid drops ejected by the fluid delivery head.

12. The fluid delivery system of claim 11, further comprising a fluid absorbent material over the fluid collector to collect fluid drops ejected by the fluid delivery head.

13. The fluid delivery system of claim 12, further comprising a waste fluid reservoir to receive fluid collected by the ink collector.

14. The fluid delivery system of claim 1, further comprising a fluid reservoir configured to supply fluid to the fluid delivery head.

15. The fluid delivery system of claim 1, wherein the fluid delivery head is an ink jet print head.

16. A method of adjusting an image, comprising:
providing a control unit that adjusts image data;
providing image data for printing on a substrate;
moving the substrate having an orientation along a conveyor;
sensing the orientation of the substrate; and
adjusting the image data based on the orientation of the substrate.

17. A method for printing an ink image on a substrate, comprising:
transporting a substrate from a first conveyor across a gap to a second conveyor; and
ejecting ink drops from an ink jet print head to the substrate when the substrate is transported over the gap between the first conveyor and the second conveyor.

18. The method of claim 17, further comprising forming an ink image on the substrate.

19. The method of claim 18, wherein ejecting ink drops from an ink jet print head includes forming an ink image that extends up to at least one edge of the substrate.

20. The method of claim 17, further comprising controlling the ink drop ejection from the ink jet print head in response to a position of the substrate.

21. The method of claim 17, further comprising collecting ink drops ejected by the ink jet print head below the gap between the first conveyor and the second conveyor.

22. The method of claim 17, further comprising collecting ink drops ejected by the ink jet print head using an ink absorbent material below the gap between the first conveyor and the second conveyor.

23. An imaging system, comprising:
a control unit for adjusting image data;
a conveyor for transporting a substrate; and
a sensor for detecting the substrate and its orientation as the substrate travels on the conveyor, wherein the sensor is coupled to the control unit;
wherein the control unit is configured to adjust the image data based on the orientation of the substrate.
